(19) United States
(12) Patent Application Publication
(10) Pub. No.: US 2013/0175421 A1
(43) Pub. Date: Jul. 11, 2013

(54) Support for Portable Electronic Device

(71) Applicants: Brett Faulk, Cypress, TX (US); Rod Shrock, San Diego, CA (US); Art Villarreal, The Woodlands, TX (US)

(72) Inventors: Brett Faulk, Cypress, TX (US); Rod Shrock, San Diego, CA (US); Art Villarreal, The Woodlands, TX (US)

(21) Appl. No.: 13/737,933

(22) Filed: Jan. 9, 2013

Related U.S. Application Data
(60) Provisional application No. 61/584,953, filed on Jan. 10, 2012.

(51) Int. Cl. F16M 13/02

(52) U.S. Cl. CPC F16M 13/02
USPC 248/463

(57) ABSTRACT

A support is disclosed that attaches to and is carried by the device that it supports. The support incorporates a u-shaped supporting member that generally extends across the length of the device, and is attached to the device using independent sidepieces that conform to the shape of the device, creating a press-fit. The sidepieces are hingedly attached to the supporting member using constant-torque positional hinges that allow for a customizable viewing angle when the device is being supported. In addition, the support is configured so that the device can be supported in two different orientations, commonly referred to as portrait and landscape, and the support is designed to support objects that are pushed and touched. Finally, the support has a minimal impact on the device's outer surfaces, so that additional attachments designed for the device may be used in conjunction with the support.

### CROSS-REFERENCE TO RELATED APPLICATIONS

This is a non-provisional application claiming priority to provisional patent application No. 61/584,953 filed on Jan. 10, 2012.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND

The present invention is in the technical field of supports and cases. More particularly, the present invention is in the technical field of supports and cases that are specifically designed for devices that are generally flat and rigid and have a physical human interface such as mobile electronic devices, namely cellular phones and tablet devices.

### SUMMARY

A support is disclosed that attaches to and is carried by the device that it supports. The support incorporates a u-shaped supporting member that generally extends across the length of the device, and is attached to the device using independent sidepieces that conform to the shape of the device, creating a press-fit. The sidepieces are hingedly attached to the supporting member using constant-torque positional hinges that allow for a customizable viewing angle when the device is being supported. In addition, the support is configured so that the device can be supported in two different orientations, commonly referred to as portrait and landscape, and the support is designed to support objects that are pushed and touched. Finally, the support has a minimal impact on the device's outer surfaces, so that additional attachments designed for the device may be used in conjunction with the support.

### BRIEF DESCRIPTION OF THE DRAWINGS

FIG. 1 is a perspective view of a support in an open landscape supporting position;

FIG. 2 is a perspective view of a support in a closed position;

FIG. 3 is a perspective view of a support in an open portrait supporting position;

FIG. 4 is a side view of a support in a landscape supporting position;

FIG. 5 is a side view of a support operating in a landscape supporting position;

FIG. 6 is a perspective view of a support connected to a device.

FIG. 7 is a perspective view of a support.

### DETAILED DESCRIPTION

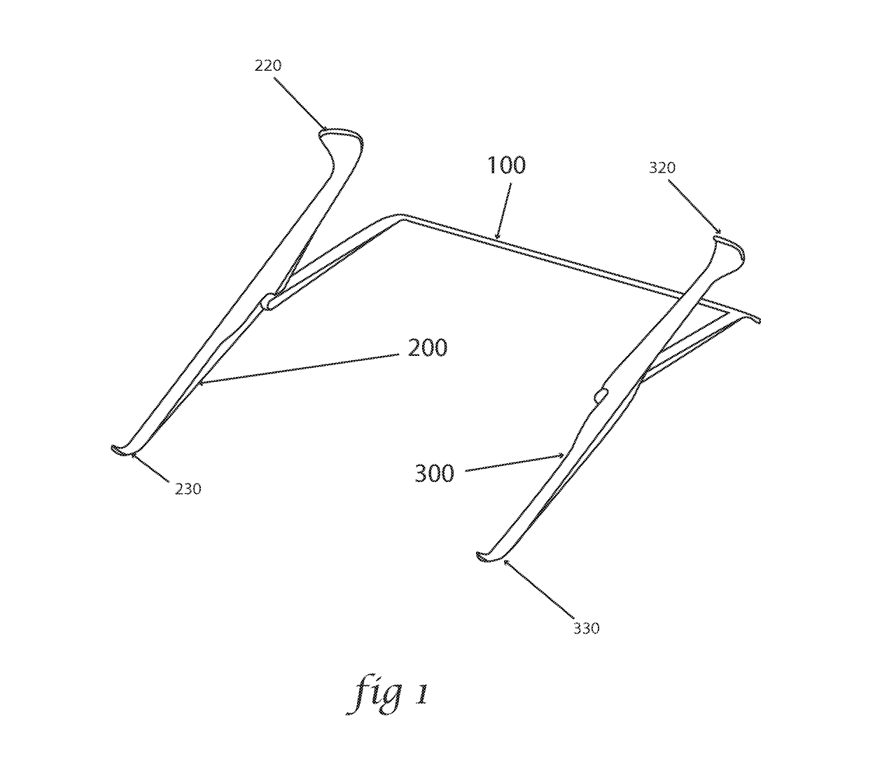

Referring now to FIG. 1, the three primary structural components of the support are shown. Support member 100 is hingedly attached to first sidepiece 200, and second sidepiece 300. Generally, support 100 has a u-shape, where the term u-shape includes shapes with rounded or angled corners, or no corners at all. The two vertical arms extending from the bottom section of support 100 have a length slightly longer than half of the length of the first and second sidepieces, 200 and 300. In the preferred embodiment, the bottom section of support 100 conforms to the shape of the object being supported.

Still referring to FIG. 1, features of the sidepieces allowing for a press-fit connection between the support and the object being supported are shown. Said features are first upper cup 220, first lower cup 230, second upper cup 320 and second lower cup 330. In the embodiment shown, first upper cup 220 and second upper cup 320 are manufactured to create a press-fit connection between the corner of the object being supported and the support. This corner connection includes a connection between the support and the object being supported on two adjacent sides of the object. In contrast, first lower cup 230 and second lower cup 330 are shaped to create a press fit between a single side of the object being supported and the support. A benefit of using at least two opposing corner press-fit connections is the avoidance of translational movement between the object being supported and the support when the support is installed. Further, the corner press-fit connection offers additional protection to the corner of the device, a feature often desired by users of portable electronic devices. Other embodiments include corner press-fit connections on both upper and lower sections of the sidepieces.

The support shown in FIG. 1 to FIG. 7 may be constructed of any rigid or semi-rigid materials. In the preferred embodiment, support member 100, first sidepiece 200, and second sidepiece 300 are constructed out of aluminum. Other metals, woods and plastics may also be used.

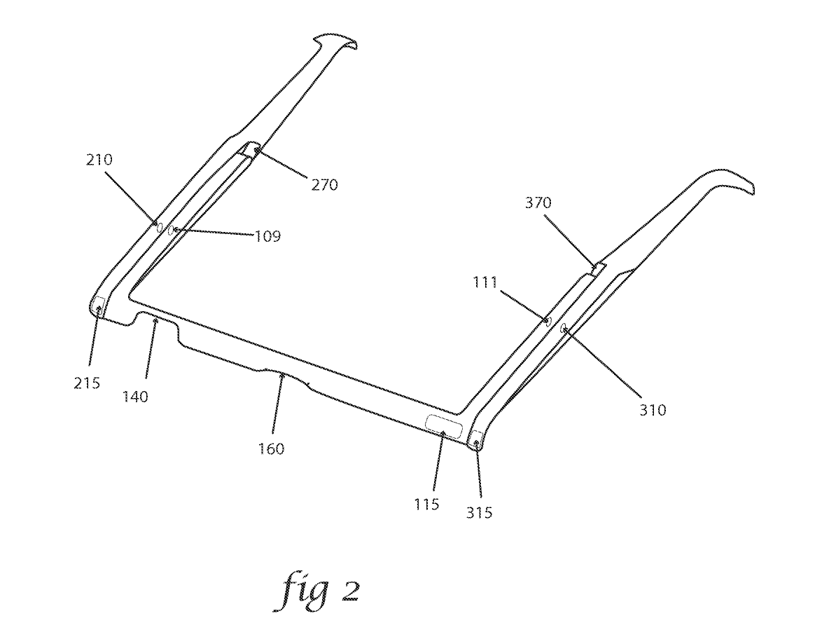

Referring now to FIG. 2, a support is shown in a closed position. To maintain this closed position a closure system is used. The preferred embodiment uses first support closure 109, second support closure 111, first sidepiece closure 210, and second sidepiece closure 310. In the preferred embodiment magnets are installed into the support generally in the positions shown with polarities arranged so that the magnets act to hold support member 100 in the closed position. Almost any method of releasably connecting support member 100 to the object being supported or two the sidepieces will suffice. Other embodiments for the closure system include a press-fit connection between support member 100, and one or both of the sidepieces, or between support member 100 and the object being supported.

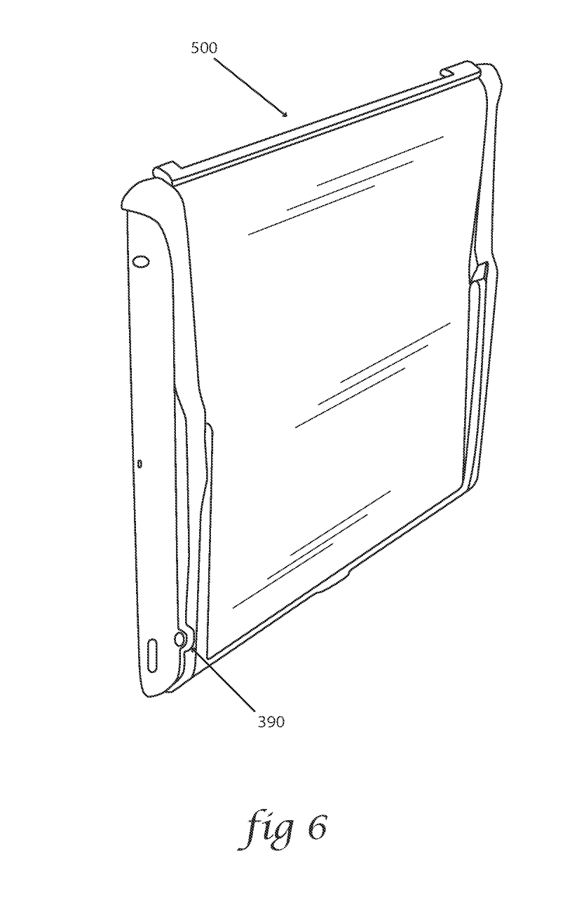

Still referring to FIG. 2, support access recess 140 is shown. Support member 100 may have multiple instances of support access recess 140, and the location and number are a function of where support member 100 resides when in the closed position, and what features of the object being supported require access by the user. For example, support access recess 140 may allow for access to a tactile power button or volume control when the support member 100 is in the closed position shown. Similarly, the sidepieces mat have recesses such as sidepiece recess 340 shown in FIG. 6.

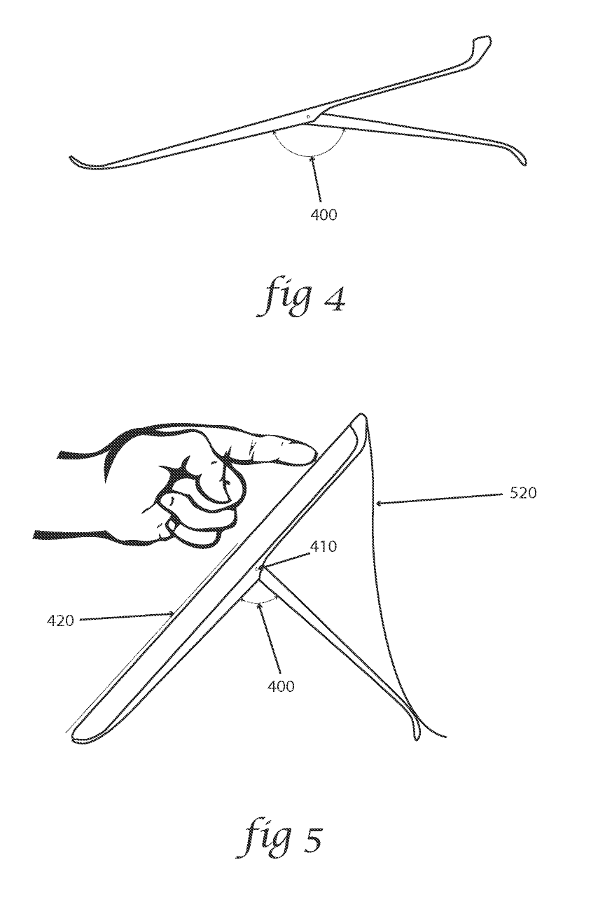

Still referring to FIG. 2, support member friction facilitator 115, first sidepiece friction facilitator 215, and second sidepiece friction facilitator 315 are shown. Said friction facilitator features ensure that when a device is being supported on a surface, as shown in FIG. 4, friction exists between the support and the surface so that the object resists sliding when touched. Said friction facilitators may be surface treatments, or additional materials that are added to the support.

Still referring to FIG. 2, support opening feature 160 is shown. In the preferred embodiment, a feature is added to support member 100 to ease the opening of the support. Here, the feature is a simple lip created by the shape of support member 100, and other solutions exists to ease the opening of the support that would instantaneously occur in the mind of one skilled in the art.

Still referring to FIG. 2, first sidepiece rotation limiter 270 and second sidepiece rotation limiter 370 are shown. Said rotation limiters are discussed further in the discussion of FIG. 4.

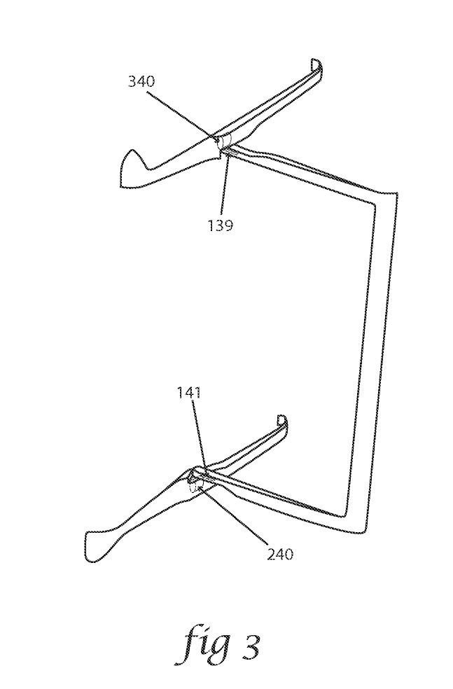

Referring now to FIG. 3, the support is shown in a portrait supporting position. Currently, many portable electronic devices display data in different orientations. These orientations are typically based on the rectangular shape of the screen of the devices, and the term landscape is used to refer to the orientation when the longest side of the screen is parallel to the horizon. The term portrait is used to refer to the orientation when the shortest side of the device is parallel to the horizon. One of the advantages of the support herein described is that the object being supported can be supported in both orientations.

Still referring to the support shown in FIG. 3, continuous torque hinges are shown. In the preferred embodiment, the connection between support member 100 and both sidepieces is that of a hinge that holds its position throughout the hinge's full range of motion. For example, a commercial off-the-shelf hinge such as the PHA 8 mm positioning hinge by Reell Precision Manufacturing would work for supports requiring consistent torques of 0.28-0.65 N-m, which torques are typically required by current portable electronic devices. Of course, said required torque varies according to the object being supported. In the embodiment shown, two positioning hinges are used, and half of the first hinge is described as second sidepiece positioning hinge 340, and the second half of said first hinge is described as support member positioning hinge 139. Similarly, half of the second hinge is described as support member positioning hinge 141, and the other half of said second hinge is described as first sidepiece positioning hinge 240.

Referring now to FIG. 4, support angle 400 is shown. As previously described, support member 100 is hingedly attached to the sidepieces using at least one positioning hinge. The use of this particular type of hinge allows for the user of the support to dictate the viewing angle of the device with great flexibility, which flexibility is often required of mobile devices. FIG. 2 shows rotation limiter features 270 and 370 that exist to protect the hinges from exceeding a particular angle, and to create a fixed maximum open position. This maximum angle, or open position is generally shown in FIG. 4. In the next figure, FIG. 5, support angle 400 is shown in one of the countless positions between the maximum angle and the closed angle.

Referring now to FIG. 5 a supported device is shown that is being touched. Many current portable electronic devices use touch screens, or other types of tactile methods to receive input from the user. Thus, the preferred embodiment incorporates features that enable users to touch the device without disturbing the supported position. Namely, hinge position 420 is not centered between the ends of the sidepieces. Rather, hinge position 420 exists above the center point between the ends of the sidepieces. Further, hinge position 420, being generally greater than half of the height of the device, results in the length support member 100's vertical arms being greater than half of the height of the device being supported. The purpose of the described hinge position is to create additional stability when the device is touched as shown, such that the device is less likely to tip over. Hinge axis of rotation 410 is shown and represents the axis of rotation of the hinge, which axis dictates hinge position 420. Moreover, the friction facilitators 115, 315, and 215 described above and shown in FIG. 2 aid in allowing for the object being supported to be touched without disturbing the supported position.

Still referring to FIG. 5, cover 520 is shown. Generally, the screens of portable electronic devices can be fragile, and susceptible to attracting debris and other unsightly annoyances such as smudges. Many covers exist in the prior art, and Cover 520 represents a cover incorporated into the support.

Referring now to FIG. 6, article attachment 500 is shown attached to a device that also has the support connected. Many attachments exist in the marketplace that are designed to attach to an edge of a device, and it is expected that new attachments will continue to emerge. One of the advantages of the support shown is that these attachments can be used in conjunction with the support. Due to the support's minimal impact on the device's edge real estate, current and future attachments can still be used with the support.

Still referring to FIG. 6, sidepiece recess 390 is shown. Sidepiece recess may exist in either or both of first sidepiece 200 or second sidepiece 300. Sidepiece recess 390 has the same purpose and functionality of support recess 140 described in the discussion of FIG. 2. There may be multiple instances of sidepiece recess 390.

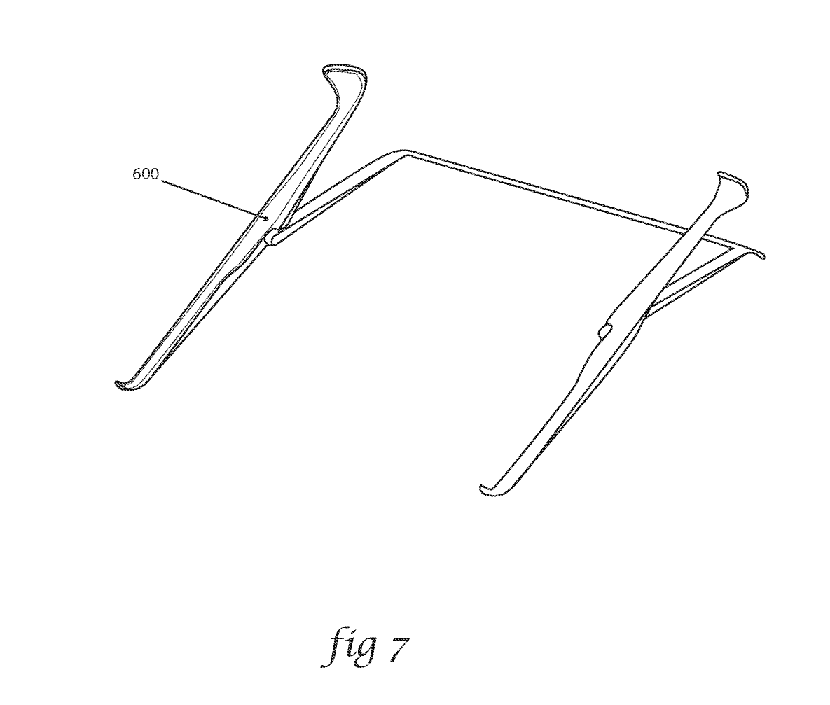

Referring now to FIG. 7, device protection 600 is shown. Device protection 600 protects the device being supported from harmful effects of the press-fit design of the support. Device protection may be a substrate applied to the sidepieces, a surface treatment, a series of discrete objects, or any other type material or feature that provides for the protection of a device during a press fit connection that is known in the art.

The advantages of the present invention include, without limitation, a support for an object that is carried by the object, offers some protection to the object, and supports the object in countless positions, including both portrait and landscape orientations. The present invention allows for other devices to attach to the object, is designed to support an object while the object is being touched, and can support the object on uneven surfaces.

In broad embodiment, the present invention is a support that attaches to an object that enables the user of the object to select from a number of supported positions, attach additional components to the object, and interact with the object using tactile inputs.

While the foregoing written description of the invention enables one of ordinary skill to make and use what is considered presently to be the best mode thereof, those of ordinary skill will understand. and appreciate the existence of variations, combinations, and equivalents of the specific embodiment, method, and examples herein. The invention should therefore not be limited by the above described embodiment, method, and examples, but by all embodiments and methods within the scope and spirit of the invention.

We claim:

1. A support for a device comprising:
a first sidepiece configured to hold at least one corner of said device;
a first continuous torque hinge attached to said first sidepiece;
a support member having a first end and a second end, wherein said support member's first end is attached to said first continuous torque hinge;
a second continuous torque hinge attached to said support member's second end;
a second sidepiece configured to hold at least one corner of said device wherein said second sidepiece is attached to said second continuous torque hinge.

2. The support of claim 1 wherein said support member is U-shaped.

3. The support of claim 1 wherein said first sidepiece and said second sidepiece includes rotation limiters.

4. The support of claim 1 wherein said first continuous torque hinge and said second continuous torque hinge include rotation limiters.

5. The support of claim 1 wherein said first sidepiece has a first end and a second end, wherein at least one of said first end or second end is configured to hold a corner of said device, and said first continuous torque hinge is attached to said first sidepiece at a location that is slightly more than half the distance between said first and second ends.

6. The support of claim 5 wherein said second sidepiece has a first end and a second, wherein at least one of said first end or second end is configured to hold a corner of said device, and said second continuous torque hinge is attached to said second sidepiece at a location that is slightly more than half the distance between said first and second ends.

7. The support of claim 1 wherein said sidepieces are shaped to hold said device corner using a press-fit.

8. The support of claim 1 wherein said a section of said support member conforms to the edge shape of said device.

9. The support of claim 1 wherein said support is made of metal.

10. The support of claim 1 further comprising device protection on the outside surfaces of at least one of said first sidepiece, second sidepiece and said support member.

11. The support of claim 1 further comprising a cover attached to at least one of said first sidepiece or said second sidepiece.

12. The support of claim 1 wherein at least one of said first sidepiece, said second sidepiece, or said support member includes at least one recesses or hole position to match the location of features of said device.

13. A support for a device comprising:
a U-shaped support member having a a first side, a bottom section, and a second side;
at least one continuous torque hinge having a first end and a second end, wherein said first end is attached to at least one of said first side or said second side;
a first side section configured to hold at least one corner of said device;
wherein said first side section is attached to said second end of said at least one continuous torque hinge;
a second side section configured to hold at least one corner of said device and hingedly attached to said second side.

14. The support of claim 13 further comprising a hinge having a first end and a second end and a hinge therebetween, wherein said hinge's first end is attached to said second side section and said hinge's second end is attached to said second side.

15. The support of claim 14 wherein said first side section has a first end and a second end, wherein at least one of said first end or second end is configured to hold a corner of said device, and said first continuous torque hinge is attached to said first side section at a location that is slightly more than half the distance between said first and second ends.

16. The support of claim 13 wherein said sidepieces are shaped to hold said device corner using a press-fit.

17. The support of claim 13 wherein said bottom section conforms to the edge shape of said device.

18. The support of claim 13 wherein said support is made of metal.

19. The support of claim 13 further comprising device protection on the outside surfaces of at least one of said first sidepiece, second sidepiece and said U-shaped support member.

20. The support of claim 1 wherein at least one of said first sidepiece, said second sidepiece, or said U-shaped support member includes at least one recesses or hole position to match the location of features of said device.
